(19) United States
(12) Patent Application Publication
(10) Pub. No.: US 2026/0251261 A1
(43) Pub. Date: Aug. 27, 2026

(54) DEVICE FOR SECURING AT LEAST ONE COUNTERWEIGHT PLATE OF A CRANE

(71) Applicant: Liebherr-Werk Ehingen GmbH, Ehingen (DE)

(72) Inventors: Mathias MANG, Ehingen (DE); Lars EBERHARDT, Staig (DE)

(21) Appl. No.: 19/545,566

(22) Filed: Feb. 20, 2026

(30) Foreign Application Priority Data
Feb. 21, 2025 (DE) 10 2025 106 624.8

(51) Int. Cl. F16M 13/02; B66C 23/74

(52) U.S. Cl. CPC F16M 13/02; B66C 23/74

(57) ABSTRACT

The present disclosure relates to a device for securing at least one counterweight plate of a crane, which comprises a rod-like base element for passing through a through-opening of at least one counterweight plate, a clamping unit that can be detachably fastened to the base element and, in the fastened state, is immovable in the longitudinal direction of the base element, and a console unit that can be fastened at different positions along the longitudinal direction of the base element, optionally wherein the console unit has a recess for passing the base element through, wherein the clamping unit and the console unit are designed to clamp at least one counterweight plate or a stack of counterweight plates arranged between them with an underlying support plate.

### CROSS REFERENCE TO RELATED APPLICATION

The present application claims priority to German Patent Application No. 10 2025 106 624.8 filed on February 21, 2025. The entire contents of the above-listed application are hereby incorporated by reference for all purposes.

### TECHNICAL FIELD

The present disclosure relates to a device for securing at least one counterweight plate of a crane, which serves to prevent individual counterweights or the entire stack from tipping and to prevent individual weight plates from unintentionally lifting off. The disclosure further relates to a system and a method for securing at least one counterweight plate of a crane.

### BACKGROUND

Especially in the case of an unintended load drop, forces can act so immensely that counterweight plates of a counterweight plate stack may lift off. This may be a particularly risky condition, which can pose risks for operating personnel in the vicinity.

### SUMMARY

Counterweights in the form of counterweight plates are used on cranes to ensure stable operation and to withstand the dynamic loads that occur during transport or in use. For example, during on-site travel on non-public roads, additional forces act on the stack, so that counterweight stacks that are only secured against a load drop are exposed to different accelerations during on-site travel (i.e. when driving a crane on a non-public road).

According to the prior art, securing the counterweight plates is usually done by using a securing chain, which primarily intercepts the undesired event of a load drop. However, this solution does not address the issue of tip-over protection for the entire weight or plate stack, particularly in configurations with higher loads where stacks up to e.g. 60 tons are provided, and yet it is still desired to move the crane on the construction site with such a large counterweight plate stack in order to enable more efficient use of the crane.

Existing approaches for securing the counterweights against load drop or tipping, such as the use of retaining brackets or centering features on the plates, have disadvantages regarding the assembly effort and the required accessibility from all sides of the stack. For example, retaining brackets must be attached on all three sides after the ballasting process, and additional compensation elements must be used to account for varying height and tolerance deviations of the weight plates. This particularly complicates use in dynamic environments and increases the installation effort. An implementation of securing a counterweight stack using retaining brackets is shown, for example, in CN 201729607 A.

The present disclosure thus aims to develop a securing device that is safe and at the same time easy to install, which ensures both tip-over protection of the entire counterweight stack and protection against the lifting off of individual weight units. The device according to the disclosure significantly simplifies assembly on the crane, so that the loads occurring during on-site travel also counteract tipping of the counterweight stack. This leads to a reliable and flexible solution that meets the requirements of modern crane applications and the growing need for higher load-bearing counterweight systems.

An implementation of the present disclosure that overcomes or at least partially mitigates the aforementioned problems is specified herein.

The device according to the disclosure for securing at least one counterweight plate of a crane comprises a rod-like base element that is designed to be inserted through a through-opening of at least one counterweight plate, a clamping unit that can be detachably fastened to the base element and, when fastened, is immovable in the longitudinal direction of the base element, as well as a console unit that can be fastened at different positions along the longitudinal direction of the base element, wherein the console unit optionally has a recess for passing the base element through. The clamping unit and the console unit are designed such that they clamp at least one counterweight plate or a counterweight plate stack arranged between them with the support plate.

The rod-like base element works together with the clamping unit and the console unit, so that a stack of counterweight plates arranged between them can be secured. For this purpose, it is provided that the clamping unit is fastened at one (lower) end of the rod-like base element, so that it is fixed in the longitudinal direction of the base element. In contrast, the console unit can be attached at different positions on the base element in order to adapt to different stack heights of counterweight plates. To achieve a clamping of a counterweight plate stack, the rod-like base element is inserted into a through-opening formed by the several counterweight plates, which is optionally located in the central area of each plate. This ensures that the opening is accessible from the bottom side as well as from the top side of the stack. Subsequently, the clamping unit can be connected to the base element at the lower end of the plate stack, so that pulling the base element upward is prevented because the contour of the clamping unit is larger than the through-opening of the support plate.

On the opposite side of the plate stack, the console unit is connected to the rod-like base element, whereby here too the contour of the console unit is larger than that of the through-opening of the counterweight plate. As a result, the console unit rests on the top side of the uppermost counterweight plate of the stack, so that attaching the clamping unit in this state can be done without the need for continuously lifting. To make the device usable for counterweight plate stacks of different heights, the console unit can be fastened at variable positions along the base element.

As a result, the device creates a clamping that, in the event of a load drop, prevents individual plates of the stack from lifting off and additionally prevents the stack from tipping.

According to a further optional modification, it can be provided that the rod-like base element has multiple openings spaced apart from each other in the longitudinal direction, for example equidistantly arranged openings, for inserting a fastening element such as a bolt or a safety pin, in order to fasten the console unit at different positions along the base element. This makes it possible to secure counterweight plate stacks of different heights with the present device.

In a further development of the disclosure, the console unit can have a collar section that is designed to partially or completely enclose an outer circumference of the rod-like base element. The collar section has at least one opening for inserting a fastening element, such as a bolt or safety pin, to fix the console unit at variable positions along the base element. It may be advantageous if the rod-like base element also has corresponding openings that are spaced apart in the longitudinal direction, so that when the opening of the collar section is aligned with an opening of the base element, a safety pin can be inserted which fixes the console unit to the base element.

Furthermore, it can be provided that the clamping unit is fastened to one of the two ends of the base element, optionally by means of a threaded connection, wherein the clamping unit has an external thread and the base element has an internal thread. For example, the clamping unit is fastened to the lower end of the base element by means of a threaded connection. In this case, the internal thread of the base element is optionally arranged at a tubular end section of the rod-like base element, into which the connecting section of the clamping unit with its external thread is screwed. This creates a connection fixed in the longitudinal direction.

According to another optional modification, it can be provided that at the end opposite the attachment point of the clamping unit, a suspension device for interacting with a crane hook is provided. This suspension device simplifies handling of the device, as an auxiliary crane or the crane whose counterweight plate(s) are to be secured can be used to lower the rod-like base element from above into the opening of the counterweight plate stack until the console unit rests on the top side of the uppermost weight plate, so that the upper end section of the base element protrudes above the stack. Subsequently, from the underside of the support plate, the clamping unit is connected to the base element, so that the counterweight plate stack is fixed or clamped between the console unit and the clamping unit.

Furthermore, the disclosure can provide that the base element is designed as a telescoping rod assembly whose length is variable, for example variably adjustable in steps. To accommodate counterweight plate stacks of different heights, the base element optionally comprises an outer tube and an inner tube. For stepwise length variability, both the outer tube and the inner tube have openings offset from each other in the longitudinal direction. When pulling the inner tube out of the outer tube, the length of the overall assembly is set as soon as an opening of the outer tube aligns with an opening of the inner tube. At this moment, for example, a safety pin or bolt can be inserted into the aligned openings, so that the inner tube is fixed relative to the outer tube and further extraction is prevented.

Moreover, the telescoping rod assembly can comprise not only two but multiple, e.g. three or four, mutually slidable telescopic elements, in order to achieve greater variability in length extension while achieving the most compact dimensions possible in the fully retracted state.

As already stated, it can be provided that the base element comprises an outer tube and an inner tube, which each have openings spaced in the longitudinal direction of the base element, in particular arranged equidistantly, for inserting a fastening element, such as a bolt or safety pin. In this way, by securing the inner and outer tubes via fasteners inserted through the openings, the total length of the base element can be varied stepwise. It may be advantageous if the spacing between two adjacent openings on the outer tube and/or inner tube corresponds to the thickness of a counterweight plate to be secured with the device. In other words, it is advantageous if the pitch of the openings along the length corresponds to the thickness of the counterweight plate to be secured.

According to another further development of the present disclosure, it can be provided that the clamping unit and the console unit, in their state fastened on the base element, have a radial extension that is at least twice, optionally at least three times, the radial extension of the base element. Due to this larger radial extension, the clamping unit and the console unit act as engagement elements to secure a counterweight plate stack in which the rod-like base element lies in aligned openings of the individual plates.

According to another optional further development, it can be provided that an extension rod is arrangeable between the clamping unit and the base element, to increase the overall length of the combination of the base element and the extension rod and thus be able to clamp tall counterweight plate stacks. It may be advantageous here that the extension rod has, at one of its two end sections, a thread, for example an external thread, for fastening to the base element, and at the other end section a thread, for example an internal thread, for fastening to the clamping unit.

Depending on the desired application configuration, the clamping unit can, for example, be fastened at the lower end of the rod-like base element or at the lower end of the extension rod, so that even particularly tall counterweight plate stacks can be securely clamped.

The disclosure further relates to a system for securing at least one counterweight plate of a crane on a counterweight support plate of the crane. This system comprises, on one hand, a device according to the aspects described above, and on the other hand at least one counterweight plate that has an opening from one flat face to the opposite flat face, as well as a counterweight support plate of the crane on whose top side at least one counterweight is placed. The counterweight support plate has an opening from its top side to its bottom side; optionally it and/or the counterweight plate is also provided with at least one centering element protruding in the stacking direction, which serves to center and laterally secure and/or position a counterweight plate placed on it. The counterweight support plate here forms the area of a crane on which, depending on the desired configuration, one or more counterweight plates are placed.

Furthermore, the disclosure relates to a crane, for example a mobile crane, that is equipped either with a device according to one of the aspects discussed above or with a system according to the aspect discussed above.

In addition, the disclosure proposes a method for securing at least one counterweight plate of a crane on a counterweight support plate of the crane – for example using a device as described above, a corresponding system or a crane according to the aspects mentioned above. The method comprises the following steps:
placing and aligning at least one counterweight plate on the counterweight support plate of the crane such that the through-opening of the counterweight plate is aligned with the opening of the counterweight support plate;
fastening the console unit to the base element;
inserting the rod-like base element into the mutually aligned openings of the counterweight plate and the counterweight support plate; and
fastening the clamping unit to the base element from the underside of the counterweight support plate, in order to prevent a counterweight plate from lifting off and to fix it in place.

Accordingly, after stacking the counterweight plates on the support plate of the crane, the length of the rod-like base element is adapted to the number of stacked counterweight plates. Once this is done, the console unit is fastened in the appropriate area, for example in the upper area, optionally the upper third, optionally at the top opening of the outer tube. Subsequently, the rod-like base element together with the fixed console unit is lifted and positioned above the aligned openings of the counterweight plates and the opening of the support plate, and lowered. This causes the console unit to rest with its surface facing the top side of the uppermost counterweight plate, since the contour of the outwardly protruding flange section of the console unit is larger than the cross-section of the opening. Thereafter, from the underside of the support plate, the clamping unit is connected to the rod-like base element, so that the counterweight plate stack, together with the support plate, is clamped.

It can further be provided that after placing and aligning at least one counterweight plate and before inserting the rod-like base element, the length of the base element is adapted to the stack height of the counterweight plate(s) placed on the support plate, for example by extending or retracting a telescoping base element and/or by attaching an extension rod, so that the length of the rod-like base element exceeds the sum of the stack height and the thickness of the counterweight support plate.

According to another development of the method, it can be provided that inserting the rod-like base element is carried out with the aid of a crane lift, wherein this is optionally performed by the crane whose counterweight plate(s) are to be secured.

### BRIEF DESCRIPTION OF THE FIGURES

Further features, details and advantages of the disclosure will become apparent from the following description of the figures. In the drawings:

FIG. 1: a view of the components of the device according to the disclosure laid out side by side,

FIG. 2: a perspective illustration of a counterweight plate, and

FIGS. 3A-3D: different deployment configurations of the device according to the disclosure for securing counterweight plate stacks of varying heights, as well as for parking the device.

### DETAILED DESCRIPTION

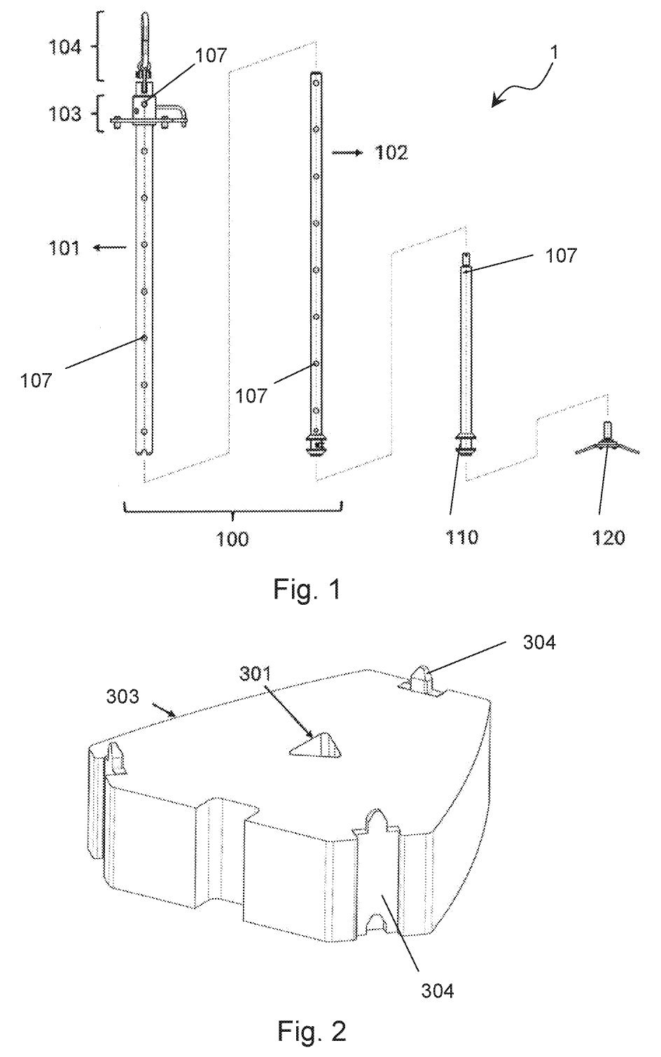

FIG. 1 shows the device 1 for securing at least one counterweight plate 302 in an illustration where the individual components are arranged next to each other. The rod-like base element 100 can be seen, which in FIG. 1 is shown as telescoping and comprises an outer tube 101 as well as an inner tube 102 that can slide into the outer tube. In order to set a specific length of the rod-like base element 100, both the outer tube 101 and the inner tube 102 have openings 107 arranged spaced apart in the longitudinal direction, which serve to fix the outer tube 101 and inner tube 102 together. For example, the inner tube 102 can be inserted into the outer tube 101 and, when a respective opening 107 of both tubes aligns, by inserting a fastening element such as a lynch pin, bolt, screw or safety pin, it is connected axially immovably with the outer tube 101.

At the lower end of the rod-like base element 100, either an extension rod 110 or the clamping unit 120 can then be fastened. For this purpose, a thread, for example an internal thread, may be provided in the lower end section of the inner tube 102, which engages with a correspondingly designed thread on the extension rod 110 or the clamping unit 120.

The extension rod 110 furthermore also has an opening 112 in the upper region of its length, in order to prevent an unintended rotational movement of the extension rod 110 relative to the rod-like base element 100 by inserting a securing element 111 into two aligned openings 112 of the base element 100 and the extension rod 110.

At its lower end, the extension rod 110 has a fastening means for attaching the clamping unit 120, so that the clamping unit 120 can optionally be attached at the lower end of the base element 100 or at the lower end of the extension rod 110.

The clamping unit 120 has a connecting section, typically in the form of an external thread, which serves to enter into a rigid connection in the longitudinal direction with the base element 100 or the extension rod 110. At the end of the clamping unit 120 opposite this connecting section, the clamping unit 120 has a portion that expands outward, extending perpendicular to the longitudinal axis, which acts as a support surface for the underside of a support plate 200 for placing a counterweight plate. In an assembled state, this expanding portion at the lower end of the clamping unit 120 has a lateral dimension that is larger than the corresponding dimension of the base element, specifically more than twice, and advantageously more than three times as large.

Also visible is the console unit 103, which is already slipped onto the rod-like base element 100 and has a collar section that partially or fully surrounds the outer circumference of the rod-like base element 100 (here, the outer tube 101). The collar section likewise has an opening, so that the console unit 103 can be fastened by means of a securing element through the openings of the base element 100. From the collar section, a flange section extends, optionally perpendicular to it, which, in the connected state, has an extension perpendicular to the longitudinal direction of the base element 100 that is more than twice, optionally more than three times, as large as the corresponding extension of the base element.

At the upper end of the base element 100, in FIG. 1 shown at the upper end of the outer tube 101, a suspension device 104 is provided, which serves to lift the entire device 1 or parts of it. This suspension device 104 can, for example, be engaged by a lifting apparatus, such as a crane, to facilitate the insertion (explained later) into a through-opening of a counterweight plate stack 300.

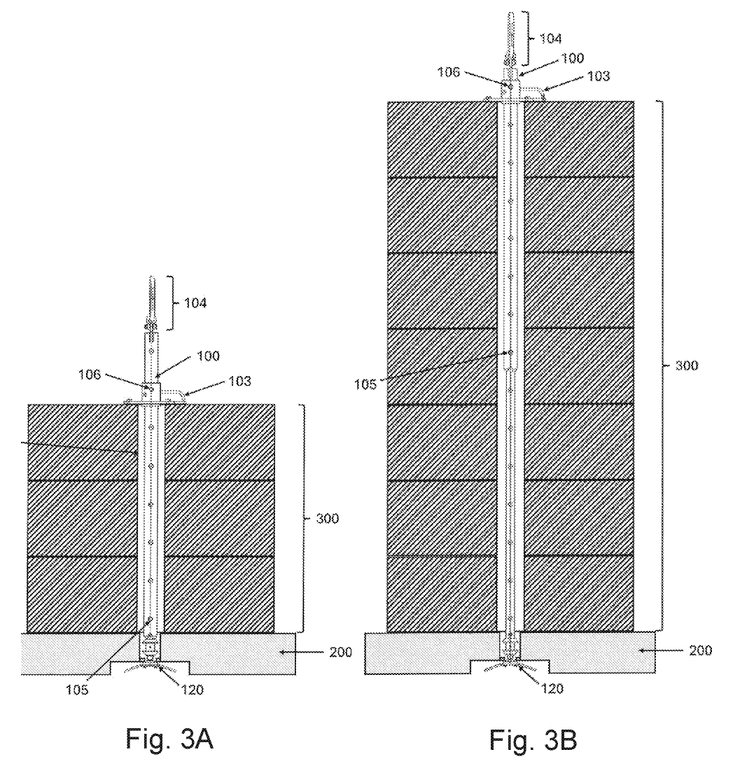

FIG. 2 shows a perspective illustration of a counterweight plate 302 that is used as ballast for heavy lifting tasks of a crane. The number of counterweight plates stacked on top of each other is chosen depending on the lifting tasks of the crane, so that only as many plates are stacked as are required for the respective task. The illustrated counterweight plate 302 serves merely as an example in this context and can of course be configured differently in other embodiments. The only requirement for using the securing device 1 is the through-opening 301, which connects the first flat face of the counterweight plate 302 with the opposite flat face. The additionally illustrated centering features 304, which allow straight stacking of multiple counterweight plates 302 and prevent the plates from slipping relative to one another, do not necessarily have to be implemented.

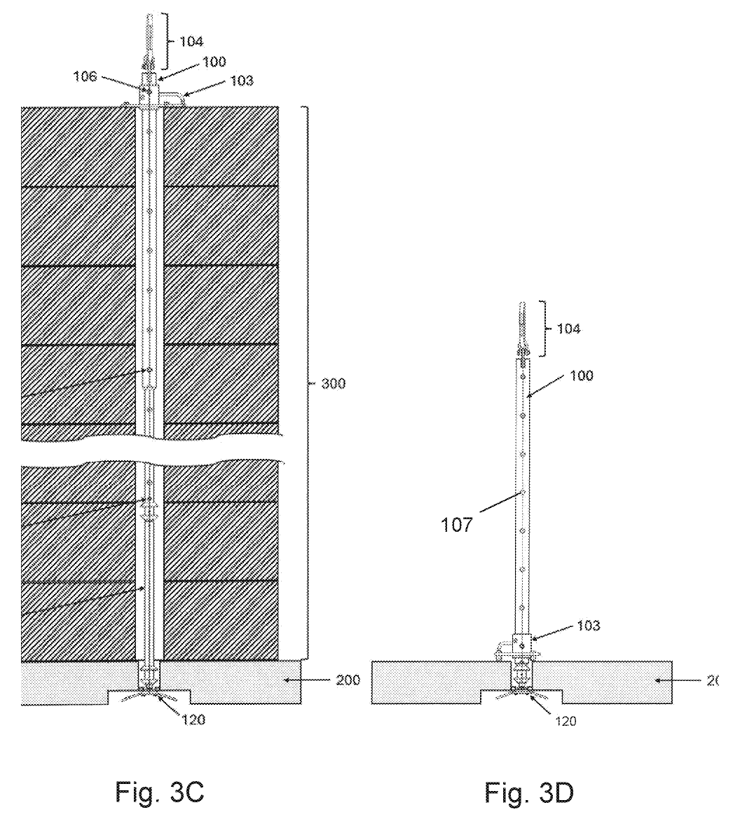

FIG. 3A shows a first configuration of the device 1 according to the disclosure with a low ballast of the crane. The counterweight plates 302 required for ballasting form the counterweight plate stack 300 and are placed on the counterweight support plate 200, wherein an opening in the support plate 200 is aligned with the respective through-opening 301 of the counterweight plates 302.

In the present case, the inner tube 102 telescopically extendable from the outer tube 101 is fully inserted and fastened to the outer tube 101 by means of a bolt 105. The clamping unit 120 is attached from the underside of the support plate 200 to the lower end of the rod-like base element 100, for example by means of an appropriate threaded connection. Depending on the height of the counterweight plate stack 300, the console unit 103 can already, prior to attaching the clamping unit, also be fastened to the base element 100 by means of a bolt 106.

It can be seen that the counterweight plates 302 placed on the support plate 200 cannot be lifted upward, since the console unit 103, in conjunction with the clamping unit 120, counteracts any such movement of the counterweight plates 302. Thus it is achieved that lifting or tipping of the counterweights is prevented.

In FIG. 3A, the entire securing device 1 consisting of outer tube 101, inner tube 102, and the console unit 103 is visible. Three counterweights are shown. These have a smaller height than the fully retracted securing device 1. Thus, the fastening element 106 must be inserted through all three components. All three counterweights must be aligned coaxially with each other. To facilitate this, a positioning device can be provided. This centers the positions of the outer tube 101 and the inner tube 102.

For this purpose, the outer tube 101 carries the recess 108 and the inner tube 102 carries the centering pin 109 (see FIG. 1). In this way, both align flush along their longitudinal axes.

It is further noted that the inner tube 102 could also be of solid design.

Furthermore, a configuration aid for the securing device by means of an instruction (affixed) on the crane is conceivable. In this way, depending on the counterweight to be placed, the required length of the securing device could be specified with the help of a code. For example, each opening 107 in the outer tube 101 could be labeled with a letter and each opening 107 in the inner tube with a number. The extension rod is additionally defined, e.g. with "V". The specification could then be "E4V". This would mean that the console 103 is to be positioned in the 5th opening (E) of the outer tube 101. The outer tube 101 is to be connected with its first opening (pin hole) to the 4th opening in the inner tube 102. Additionally, the extension rod 110 is to be installed.

FIG. 3B shows a configuration for a medium ballast of the crane, in which the outer tube 101 and the inner tube 102 are adjusted in their length to the increased number of counterweight plates 302 stacked. For this, the inner tube 102 is pulled out of the outer tube 101 and, once a length corresponding to the counterweight plate stack 300 is reached, pinned in place. The securing element 105 in this case is a bolt that is inserted into two aligned openings of the outer tube 101 and the inner tube 102.

FIG. 3C shows a configuration for a high ballast of the crane, where the maximum length of the rod-like base element is not sufficient and therefore an extension rod is attached. The fundamental operating principle of the device 1 remains identical. However, to reach the required length, which is determined by the aligned openings of the counterweight plates 302 and the opening of the support plate 200, the extension rod 110 is fastened to the lower end of the inner tube 102. This fastening is typically carried out by means of a threaded connection, in which an unintentional rotation is prevented by a separately provided bolt connection. For this purpose, the extension rod 110 also has an opening in its upper region, so that when it is aligned with an opening of the inner tube 102, it can be secured by a securing element 111, for example a lynch pin for pipes, ensuring that the engaged threaded connection can no longer be unintentionally loosened.

FIG. 3D shows a parking position of the device according to the disclosure, in which the telescoping base element 100 is brought into its minimum length configuration, i.e. the inner tube 102 is fully inserted into the outer tube 101, while at the same time the console unit 103 is fastened in a lower region of the base element 100. The base element 100 equipped with the console unit 103 is lifted above the support plate 200 and inserted into the opening provided there, so that the console unit 103 rests on the top side of plate 200. In this configuration, in the area below the console unit 103 of the base element 100, it is arranged that it engages into the opening of the plate 200 or even passes through it. As a result, from the underside of plate 200, the clamping unit 120 can be attached to the base element, whereby the device 1 is clamped to plate 200 and normal operation of the crane associated with plate 200 is ensured.

### REFERENCE NUMERAL LIST

1 securing device

100 rod-like base element

101 outer tube

102 inner tube

103 console unit

104 suspension device

105 fastening element for pinning inner tube to outer tube

106 fastening element for pinning base element to console

107 opening for inserting a securing element

108 recess

109 centering pin

110 extension rod

111 fastening element for pinning outer tube to extension rod

112 opening

120 clamping unit

200 support plate for the counterweights on the crane

300 counterweight plate stack

301 through-opening in the counterweight plate

302 counterweight plate

303 through-opening in the support plate

304 centering element

1. A device for securing at least one counterweight plate of a crane, comprising:
a rod-like base element for passing through a through-opening of at least one counterweight plate;
a clamping unit that can be detachably fastened to the base element and is immovable in a longitudinal direction of the base element when fastened; and
a console unit that is fastenable at different positions along the longitudinal direction of the base element;
wherein the clamping unit and the console unit are configured to clamp at least one counterweight plate or a stack of counterweight plates arranged between them with a support plate.

2. The device according to claim 1, wherein the rod-like base element has multiple openings spaced apart in the longitudinal direction of the base element for inserting a fastening element in order to fasten the console unit at different positions along the longitudinal direction of the rod-like base element.

3. The device according to claim 1, wherein the console unit has a collar section that is designed to partially or fully enclose an outer circumference of the rod-like base element and has at least one opening for inserting a fastening element, in order to fasten the console unit at different positions along the longitudinal direction of the rod-like base element.

4. The device according to claim 1, wherein the clamping unit is attachable to one of the two ends of the base element.

5. The device according to claim 1, wherein at the end opposite the attachment point of the clamping unit, a suspension device for interacting with a crane hook is provided.

6. The device according to claim 1, wherein the base element is a telescoping rod assembly whose length is variable.

7. The device according to claim 6, wherein the base element comprises an outer tube and an inner tube, and wherein each of which have openings spaced apart in the longitudinal direction of the base element for inserting a fastening element, such that by fastening the inner tube and the outer tube through their aligned openings a total length of the base element can be varied in steps.

8. The device according to claim 1, wherein the clamping unit and the console unit, in their state fastened on the base element, have an extension, radial to the base element, that is larger than the radial extension of the base element by at least two times.

9. The device according to claim 1, further comprising an extension rod that can be arranged between the clamping unit and the base element, and that serves to increase an overall length of the combination of the base element and the extension rod in order to clamp tall counterweight plate stacks.

10. The device according to claim 9, wherein the extension rod has, at one of its two end sections, a thread for fastening to the base element, and at the other of its two end sections a thread for fastening to the clamping unit.

11. A system for securing at least one counterweight plate of a crane on a counterweight support plate of the crane, comprising:
the device according to claim 1;
at least one counterweight plate that has a through-opening from one flat side to the opposite flat side of the counterweight plate; and
a counterweight support plate of the crane for placing at least one counterweight on its top side,
wherein the counterweight support plate has a through-opening from its top side to its bottom side of the counterweight support plate.

12. A crane having the device according to claim 1, wherein the crane is a mobile crane.

13. A method for securing at least one counterweight plate of a crane on a counterweight support plate of the crane using the device according to claim 1, comprising the steps:
placing and aligning at least one counterweight plate on the counterweight support plate of the crane such that the through-opening of the at least one counterweight plate is aligned with the through-opening of the counterweight support plate;
fastening the console unit to the base element;
inserting the rod-like base element into the mutually aligned openings of the at least one counterweight plate and the counterweight support plate; and
fastening the clamping unit to the base element from the underside of the counterweight support plate, to prevent a counterweight plate from lifting off and to fix the at least one counterweight plate placed on the counterweight support plate.

14. The method according to claim 13, wherein after placing and aligning at least one counterweight plate and before inserting the rod-like base element, the length of the rod-like base element is adapted to the stack height of the at least one counterweight plate placed on the counterweight support plate, so that the length of the rod-like base element exceeds the sum of the stack height and the thickness of the counterweight support plate.

15. The method according to claim 13, wherein inserting the rod-like base element is carried out with the aid of a crane lift.

16. The device according to claim 1, wherein the console unit has a recess for passing the base element through.

17. The device according to claim 2, wherein the multiple openings spaced apart in the longitudinal direction of the base element are equidistantly arranged openings.

18. The device according to claim 2, wherein the fastening element is a bolt or a safety pin.

19. The device according to claim 4, wherein the clamping unit is attachable to one of the two ends of the base element by means of a threaded connection, and wherein the clamping unit has an external thread and the base element has an internal thread.

20. The device according to claim 6, wherein the length of the telescoping rod assembly is adjustable in steps.
